(19) United States
(12) Patent Application Publication
(10) Pub. No.: US 2002/0030724 A1
(43) Pub. Date: Mar. 14, 2002

(54) Recording mechanism, ink-jet recording apparatus, and image-capturing apparatus having the recording appatatus

(76) Inventor: Junji Shimoda, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/947,379

(22) Filed: Sep. 7, 2001

(30) Foreign Application Priority Data
Sep. 12, 2000 (JP) 277083/2000

(51) Int. Cl. B41J 29/13

(52) U.S. Cl. 347/108

(57) ABSTRACT

An ink-jet recording apparatus for forming an image by discharging ink from an ink discharging nozzle onto a recording medium includes a carriage which is moved for scanning along a pair of guide shafts, and a recording head having ink discharging nozzles arranged in a row. An ink chamber is integrally formed in the carriage, and a heater board is integrally mounted on the carriage so that the ink chamber communicates with the ink discharging nozzles. The guide shafts pass through both end portions of the carriage with the discharging nozzles therebetween so as to be orthogonal to the row of ink discharging nozzles. The ink-jet recording apparatus is applicable to a printer in a printer-containing camera.

### BACKGROUND OF THE INVENTION

1. Field of the Invention

The present invention relates to a recording mechanism, an ink-jet recording apparatus, and an image-capturing apparatus having the recording apparatus. More particularly, the present invention relates to a recording mechanism in which an ink discharging head and an ink container are integrally mounted on a carriage, an ink-jet recording apparatus having the recording mechanism, and an image-capturing apparatus with a recording apparatus in which the ink-jet recording apparatus is applied to a printer in a printer-containing camera.

2. Description of the Related Art

Conventionally, so-called serial scan type ink-jet recording apparatuses are used in printers, copying machines, facsimiles, and the like, in which a recording head and a replaceable ink tank serving as an ink container are mounted on a carriage which is movable in the main scanning direction. In the ink-jet recording apparatuses, images are sequentially recorded on a recording medium by repeating a main scanning operation of the carriage with the head and the ink tank, and a sub-scanning operation of the recording medium.

In such recording apparatuses in which the recording head and the replaceable ink tank are mounted on the carriage, the structure is complicated, the number of components is large, and size reduction is difficult. Moreover, because the carriage moves at high speed, when the size is reduced, shaking of the carriage becomes more pronounced, thereby having a serious effect on image quality.

In recent years, there has been a demand for smaller ink-jet recording apparatuses which can be used for a wider variety of applications. However, there are limitations to the size reduction attainable only by simply reducing the sizes of the recording head and the ink tank.

### SUMMARY OF THE INVENTION

The present invention aims to overcome the above problems of the conventional art, and provides a recording mechanism with a substantially reduced size and weight, provides a reliable ink-jet recording apparatus while achieving cost reduction, and provides an image-capturing apparatus with a recording apparatus which can be used in a wider scope of technical applications of the ink-jet recording apparatus.

In order to achieve the foregoing, according to an aspect of the present invention, there is provided a recording mechanism of an ink-jet recording apparatus for forming an image by discharging ink from at least one ink discharging nozzle onto a recording medium, including a carriage which is moved for scanning along a guide shaft, an ink chamber integrally formed in the carriage, and a recording head comprising the at least one ink discharging nozzle also integrally mounted on the carriage.

According to another aspect of the present invention, there is provided an ink-jet recording apparatus for forming an image by discharging ink from at least one ink discharging nozzle onto a recording medium, the ink-jet recording apparatus including a carriage to be moved for scanning along a guide shaft, a recording head comprising the at least one ink discharging nozzle, and an ink chamber containing the ink to be supplied to the recording head, wherein the ink chamber is integrally formed in the carriage, and the recording head is integrally mounted on the carriage so that the ink chamber communicates with the at least one ink discharging nozzle.

According to yet another aspect of the present invention, an image-capturing apparatus includes an ink-jet recording apparatus for forming an image by discharging ink from at least one ink discharging nozzle onto a recording medium. The image-capturing apparatus includes a carriage, a recording head, and an ink chamber. The carriage is moved for scanning along a guide shaft. The recording head comprises the at least one ink discharging nozzle. The ink chamber contains ink to be supplied to the recording head. The ink chamber is integrally formed in the carriage, and the recording head is integrally mounted on the carriage so that the ink chamber communicates with the at least one ink discharging nozzle.

According to still another aspect of the present invention, a recording mechanism of an ink-jet recording apparatus for forming an image by discharging ink from an ink discharging nozzle onto a recording medium includes a carriage, a bearing and a recording head. The carriage comprises an ink chamber containing ink to be supplied to the ink discharging nozzle and the bearing is formed in the ink chamber so as to allow the carriage to be moved for scanning along a guide shaft. The recording head comprises the ink discharging nozzle and is integrally mounted on the ink chamber.

According to yet another aspect of the present invention, an ink-jet recording apparatus for forming an image by discharging ink from an ink discharging nozzle onto a recording medium includes a recording head and an ink chamber. The recording head comprises the ink discharging nozzle. The ink chamber contains ink to be supplied to the recording head. The recording head is integrally mounted on the ink chamber, and the ink chamber comprises a bearing for receiving a guide shaft along which the recording head is moved for scanning.

Further objects, features, and advantages of the present invention will become apparent from the following description of the preferred embodiments with reference to the attached drawings.

### BRIEF DESCRIPTION OF THE DRAWINGS

FIG. 1 is a front view of a printer-containing camera to which the present invention is applied.

FIG. 2 is a front perspective view of the camera shown in FIG. 1.

FIG. 3 is a rear perspective view of the camera shown in FIG. 1.

FIG. 4 is a perspective view of a media pack which is loadable in the camera.

FIG. 5 is a perspective view showing the positional relationship among the principal components of the camera.

FIG. 6 is a perspective view of a printer unit shown in FIG. 5.

FIG. 7 is a partly cutaway perspective view of the printer unit shown in FIG. 6.

FIG. 8 is a perspective view of a carriage in the printer unit.

FIG. 9 is a perspective view of components of a printing medium feeding system in the printer unit.

FIG. 10 is a perspective view of components of an ink supply system in the printer unit.

FIG. 11 is a plan view showing a state in which a media pack is loaded in the ink supply system shown in FIG. 10.

FIG. 12 is a general block diagram of a camera unit and the printer unit in the camera shown in FIG. 1.

FIG. 13 is a block diagram showing signal processing in the camera unit shown in FIG. 12.

FIG. 14 is a block diagram showing signal processing in the printer unit shown in FIG. 12.

FIG. 15 is a perspective view of a carriage and its surroundings in an ink-jet recording apparatus according to the present invention.

FIGS. 16A and 16B are sectional views of the carriage of the ink-jet recording apparatus respectively showing a state before the carriage is assembled and a state after the carriage is assembled.

### DESCRIPTION OF THE PREFERRED EMBODIMENTS

An embodiment of the present invention will be described below with reference to the attached drawings.

In this specification, “printing” (sometimes referred to as “recording”) broadly encompasses not only forming meaningful characters, graphics, and the like based on information, but also forming images, patterns, and the like on printing media or performing processing on printing media, whether or not the images and the like are meaningful and whether or not they are visible to the human eye.

A “printing medium” broadly encompasses not only paper to be used in a general type of printing apparatus, but also other materials which can receive ink, such as cloth, a plastic film, a metal plate, glass, ceramics, wood, and leather. Hereinafter, the printing medium will also be referred to as a “sheet” or simply as “paper”.

A “camera” means an instrument and a device which optically captures an image and converts the optical image into electrical signals. In the following description, the “camera” will also be referred to as an “image-capturing unit”.

Furthermore, “ink” (sometimes referred to as “liquid”) is broadly defined herein in a manner similar to that of the above “printing”, and means a liquid which is applied on a printing medium and is used to form images, patterns, and the like thereon, to process a printing medium, or to process ink (for example, to coagulate or insolubilize coloring materials in the ink applied on a printing medium).

An embodiment of a recording head to which the present invention is effectively applied causes film boiling in a liquid by using heat energy produced by an electrothermal conversion member, and thereby forms bubbles.

[Basic Configuration]

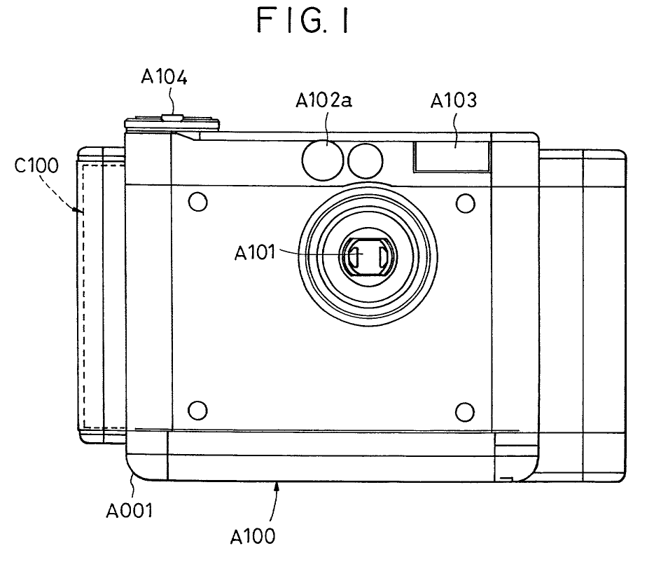

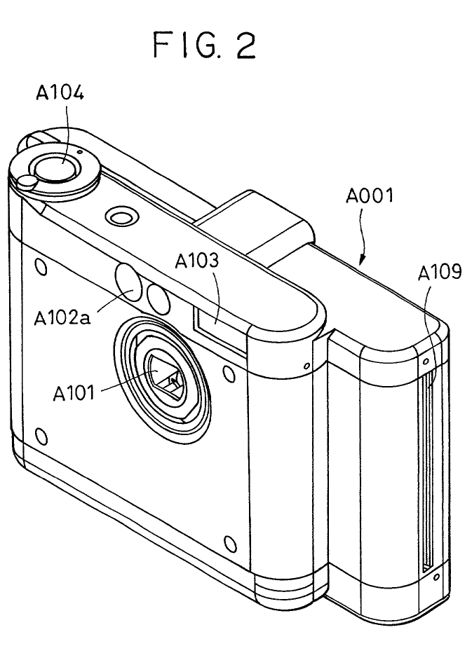

First, the basic configuration of an information processing apparatus according to an embodiment of the present invention will be described with reference to FIGS. 1 to 14. The information processing apparatus comprises an image-capturing section (hereinafter also referred to as a “camera unit”) for optically capturing an image and converting the image into electrical signals, and an image recording section (hereinafter also referred to as a “printer unit”) for recording an image based on the electrical signals of the captured image. In the following description, the image processing apparatus is called a “printer-containing camera”.

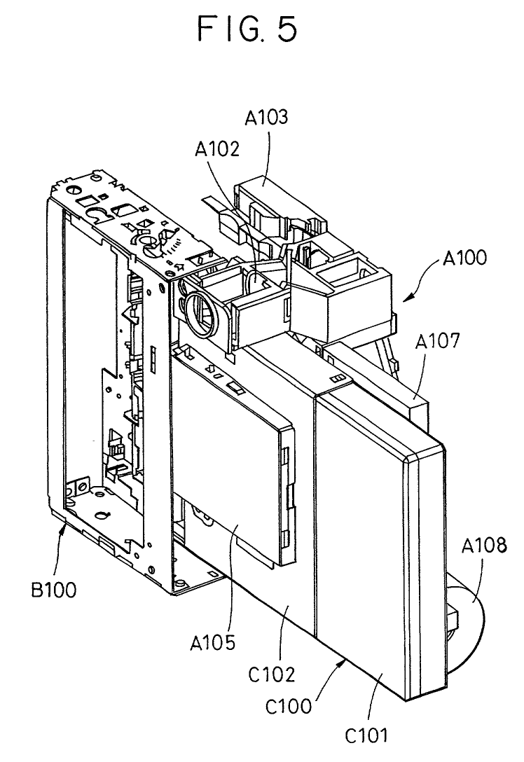

In a main body A001, a printer unit (recording section) B100 is incorporated on the rear side of a camera unit A100. The printer unit B100 records images by using ink and printing media which are supplied from a media pack C100. FIG. 5 is a rear view of the main body A001, from which an outer cover is removed. As shown in FIG. 5, the media pack C100 is inserted in the right part of the main body A001, and the printer unit B100 is disposed in the left part thereof. In order for the printer unit B100 to perform recording, the main body A001 can be placed in a recording position such that a liquid crystal display A105 of the camera unit A100, which will be described later, faces up and a lens A101 faces down. In the recording position, a recording head B120 of the printer unit B100, which will be described later, discharges ink downwardly. The recording position is not limited to the above position, and may be similar to an image-capturing position of the camera unit A100. In order to stabilize a recording operation, the above recording position where ink is discharged downwardly is preferable.

The basic mechanical configuration of the apparatus of this embodiment will be described in the following sections, that is, A. Camera Unit, B. Media Pack, and C. Printer Unit. The basic configuration of a signal processing system will be described in D. Signal Processing System.

A. Camera Unit

The camera unit A100 is basically formed of a general type of digital camera, and is integrated in the main body A001 with the printer unit B, which will be described later, thereby constituting a printer-containing digital camera having the outer appearance shown in FIGS. 1 to 3. Referring to FIGS. 1 to 3, the camera unit A100 comprises a lens A101, a viewfinder A102, a viewfinder window A102a, an electronic flash A103, a release button A104, and a liquid crystal display (external display) A105. As will be described later, the camera unit A100 processes data on images captured with a CCD, stores images in a compact flash memory card (CF card) A107, displays images, and exchanges various data with the printer unit B. A printing medium C104 on which a captured image is recorded, which will be described later, is discharged from a discharge section A109. A battery A108 shown in FIG. 5 functions as a power supply for the camera unit A100 and the printer unit B100.

B. Media Pack

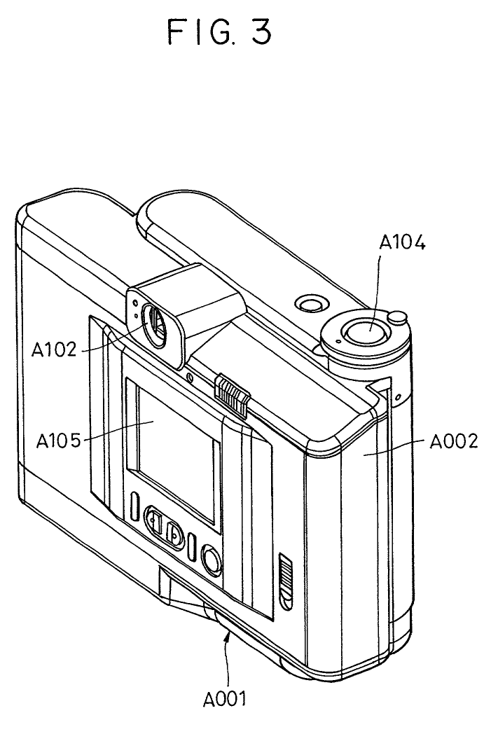

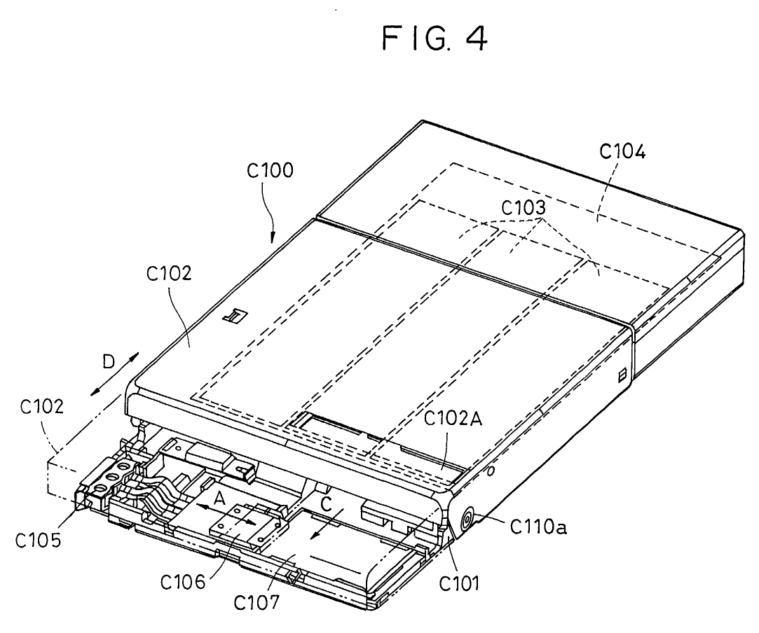

The media pack C100 is detachably loaded in the main body A001. In this embodiment, the media pack C100 is loaded into the main body A001 through an insertion slot A002 (see FIG. 3), as shown in FIG. 1. The insertion slot A002 is closed, as shown in FIG. 3, when the media pack C100 is not loaded, and is opened when the media pack C100 is inserted. FIG. 5 shows the main body A001 with the media pack C100 loaded therein, from which an outer cover is removed. A pack body C101 of the media pack C100 is provided with a shutter C102 which is slidable in a direction of arrow D in FIG. 4. The shutter C102 is placed at a position shown by a two-dot chain line in FIG. 4 when the media pack C100 is not loaded, and is placed at a position shown by a solid line in FIG. 4 when the media pack C100 is loaded.

Ink packs C103 and printing media C104 are contained in the pack body C101. In FIG. 4, the ink packs C103 are placed under the printing media C104. In this embodiment, three ink packs C103 are provided so as to contain Y (yellow), M (magenta), and C (cyan) inks, respectively, and approximately twenty printing media C104 are stacked. A combination of ink and printing media C104 best suited to image recording is selected, and is contained in the same media pack C100. Therefore, various media packs C100 having different combinations of ink and printing media (for example, media packs for ultra-high quality, normal quality, and seals (split seals)) are prepared, and are selectively loaded in the main body A001 according to the type of images to be recorded and the use of printing media having an image thereon. This makes it possible to reliably record an image suited to the purpose by using the optimum combination of ink and a printing medium. The media pack C100 is also provided with an EEPROM (identification IC) which will be described later. The EEPROM stores identification data, such as the types of ink and printing media contained in the media pack C100.

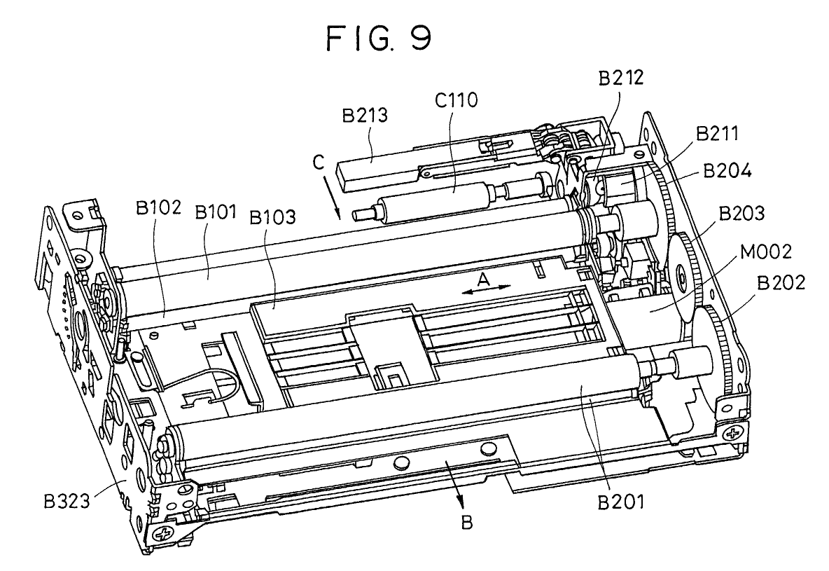

When the media pack C100 is loaded in the main body A001, the ink packs C103 are connected to an ink supply system of the main body A001 through three corresponding joints C105 for Y, M, and C inks. On the other hand, printing media C104 are separated one by one by a separation mechanism (not shown), and are conveyed in a direction of arrow C by a delivery roller C110 (see FIG. 9), which will be described later. The driving force for the delivery roller C110 is supplied from a delivery motor M002 of the main body A001 (see FIG. 9), which will be described later, via a connecting portion C110a.

The pack body C101 is also provided with a wiper C106 for wiping a recording head of the printer unit B100, which will be described later, and an ink absorber C107 for absorbing waste ink discharged from the printer unit B100. The recording head of the printer unit B100 reciprocally moves in a main scanning direction of arrow A, as will be described later. When the media pack C100 is not loaded in the main body A001, the shutter C102 slides to the position shown by the two-dot chain line in FIG. 4 so as to protect the joints C105, the wiper C106, the ink absorber C107, and the like.

C. Printer Unit

The printer unit B100 of this embodiment is of a serial type using an ink-jet recording head. The printer unit B100 will be described below in the following sections, that is, C-1 Printing Section, C-2 Printing Medium Feeding System, and C-3 Ink Supply System.

C-1 Printing Section

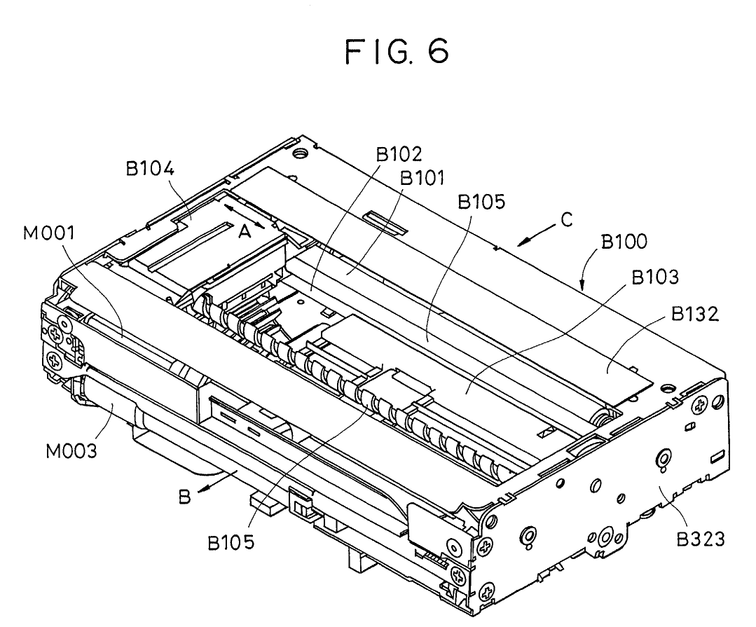

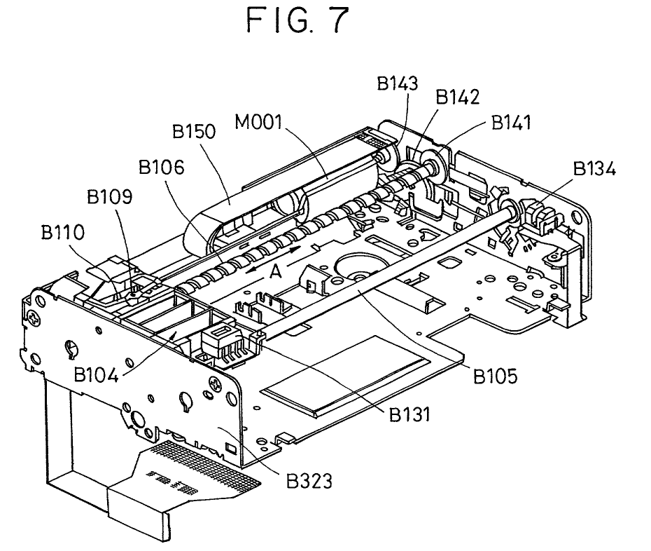

FIG. 6 is a general perspective view of the printer unit B100, and FIG. 7 is a partly cutaway perspective view of the printer unit B100.

As shown in FIG. 5, the leading end of the media pack C100 loaded in the main body A001 is placed at a fixed position inside the body of the printer unit B100. A printing medium C104 fed out from the media pack C100 in a direction of arrow C is conveyed on a platen B103 in a sub-scanning direction of arrow B while being nipped between an LF roller B101 and an LF pinch roller B102 of the printing medium feeding system which will be described later. A carriage B104 is reciprocally moved in the main scanning direction of arrow A along a guide shaft B105 and a lead screw B106.

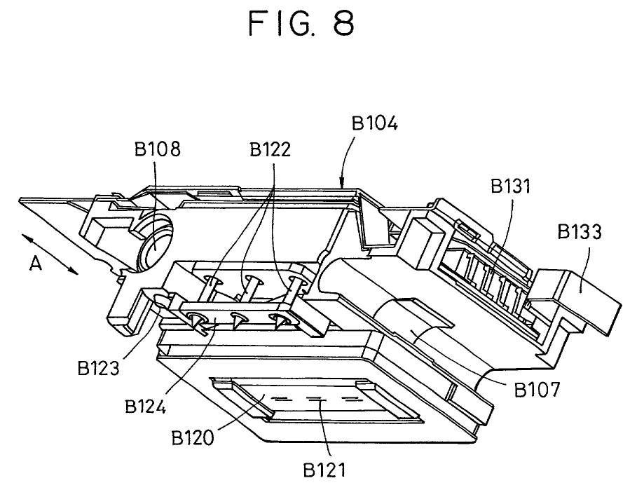

The carriage B104 includes a bearing B107 for the guide shaft B105, and a bearing B108 for the lead screw B106, as shown in FIG. 8. A screw pin B109 protruding inside the bearing B108 is attached at a fixed position of the carriage B104 by a spring B110, as shown in FIG. 7. The leading end of the screw pin B109 is fitted in a spiral groove formed on the outer periphery of the lead screw B106 so that the rotation of the lead screw B106 is converted into the reciprocal motion of the carriage B104.

An ink-jet recording head B102 for discharging Y, M, and C inks and a subtank (not shown) containing the ink to be supplied to the recording head B120 are mounted on the carriage B104. The recording head B120 has a plurality of ink discharging outlets B121 (see FIG. 8) arranged in a direction crossing the main scanning direction of arrow A (a direction orthogonal thereto in this embodiment). The ink discharging outlets B121 form nozzles which discharge ink supplied from the subtanks. As an energy generator for discharging ink, an electrothermal conversion member is provided for each nozzle. The electrothermal conversion member is driven to generate heat, and produces bubbles in the ink inside the nozzle. Ink droplets are discharged from the ink discharging outlets B121 by the energy of the bubbles.

The subtank has a capacity smaller than that of the ink packs C103 held in the media pack C100 such as to contain at least an amount of ink necessary for image recording on one printing medium C104. Ink containers for Y, M, and C inks in the subtank respectively include ink supply portions and negative pressure inlets. The ink supply portions are respectively connected to three corresponding hollow needles B122, and the negative pressure inlets are connected to a common air supply port B123. When the carriage B104 is moved to a home position shown in FIG. 6, ink is supplied from the ink packs C103 of the media pack C100 to such a subtank, as will be described later.

In the carriage B104, when the needles B122 and the joints C105 are not connected to each other, a needle cover B124 is placed at a position such as to protect the needles B122 by the spring force, as shown in FIG. 8. When the needles B122 and the joints C105 are connected, the needle cover B124 is pushed upward in FIG. 8 against the spring force, and is placed out of the needle protecting position. The position of the carriage B104 is detected by an encoder sensor B131 of the carriage B104 and a linear scale B132 of the body of the printer unit B100 (see FIG. 6). It is detected by an HP (home position) flag B133 of the carriage B104 and an HP sensor B134 of the body of the printer unit B100 (see FIG. 7) that the carriage B104 is placed at the home position.

In FIG. 7, at both ends of the guide shaft B105, support shafts (not shown) are disposed so as to be decentered from the center axis. By turning the guide shaft B105 about the support shafts, the position of the carriage B104 is adjusted, and the distance between the recording head B120 and a printing medium C104 on the platen B103 (also referred to as a “paper distance”) is also adjusted. The lead screw B106 is rotated by a carriage motor M001 via a screw gear B141, an idler gear B142, and a motor gear B143. A flexible cable B150 electrically connects a control system, which will be described later, and the recording head B120.

The recording head B120 discharges ink from the ink discharging outlets 121 according to image signals while moving together with the carriage B104 in the main scanning direction of arrow A, thereby recording one line on a printing medium on the platen B103. By repeating such an operation of the recording head B120 for recording one line 15. and an operation of a printing medium feeding system, which will be described later, for feeding a printing medium by a predetermined amount in the sub-scanning direction of arrow B, images are sequentially recorded on the printing medium.

C-2 Printing Medium Feeding System

FIG. 9 is a structural perspective view of the printing medium feeding system in the printer unit B100. Referring to FIG. 9, one of a pair of discharge rollers B201, which is placed on the upper side, is driven by a feeding motor M002 via a discharge roller gear B202 and an intermediate gear B203. Similarly, the above-described LF roller B101 is driven by the feeding motor M002 via an LF roller gear B204 and the intermediate gear B203. The discharge roller B201 and the LF roller B101 are driven by the forward rotational force of the feeding motor M002 so as to convey a printing medium C104 in the sub-scanning direction of arrow B.

In contrast, when the feeding motor M002 is reversely rotated, a platen head B213 and a lock mechanism (not shown) are driven via a switch slider B211 and a switch cam B212, and the driving force is transmitted to the delivery roller C110 of the media pack C100. That is, the platen head B213 is passed through a window C102A (see FIG. 4) of the shutter C102 of the media pack C100 by the reverse rotational force of the feeding motor M002, and presses printing media C104, which are stacked in the media pack C100, downward in FIG. 4. The lowermost printing medium C104 is thereby pressed against the delivery roller C110 of the media pack C100. The lock mechanism (not shown) locks the media pack C100 in the main body A001 by the reverse rotational force of the feeding motor M002 so as to prohibit the media pack C100 from being unloaded. When the delivery roller C110 of the media pack C100 receives the reverse rotational force of the feeding motor M002, it feeds out the lowermost printing medium C104 in the direction of arrow C in FIG. 4.

In this way, when the feeding motor M002 is reversely rotated, only one of the printing media C104 is fed out from the media pack C100 in the direction of arrow C. Subsequently, the feeding motor M002 is rotated forward, and the printing medium C104 is conveyed in the direction of arrow B.

C-3 Ink Supply System

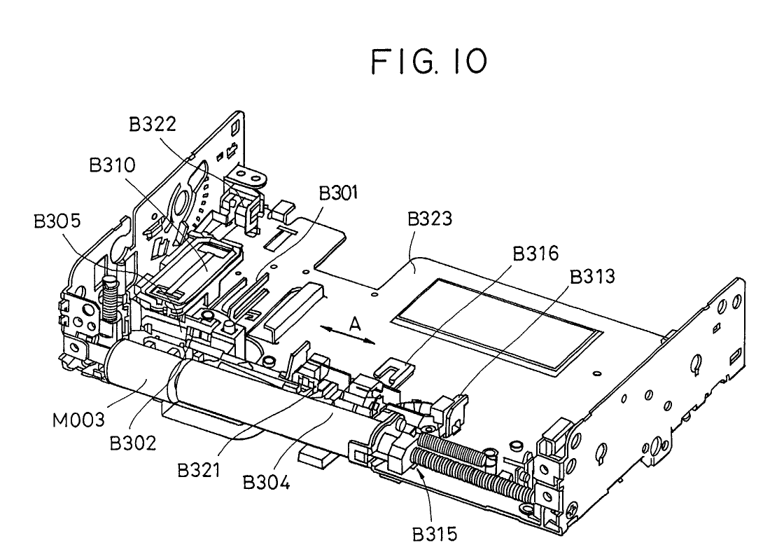

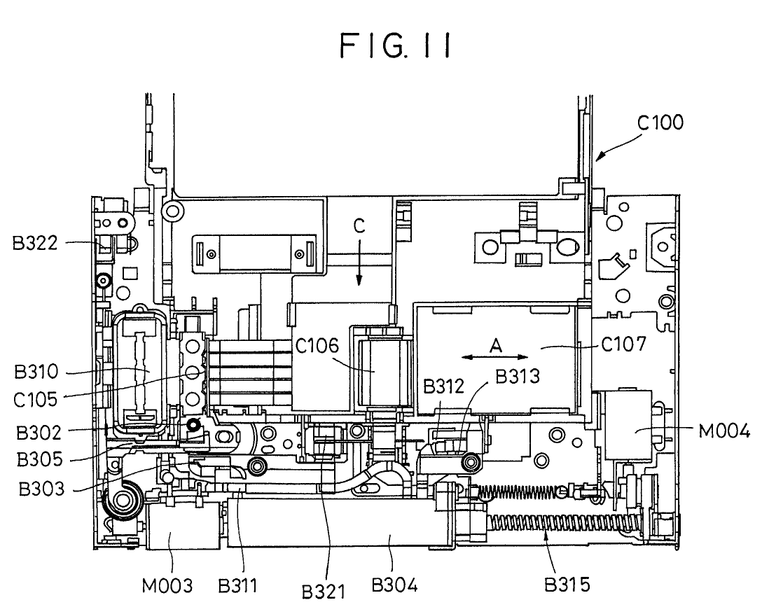

FIG. 10 is a structural perspective view of the ink supply system of the printer unit B100, and FIG. 11 is a plan view showing a state in which the media pack C100 is loaded in the ink supply system.

The joints C105 of the media pack C100 loaded in the printer unit B100 are positioned below the needles B122 (see FIG. 8) of the carriage B104 which has moved to the home position. A joint fork B301 (see FIG. 10) is formed in the body of the printer unit B100 so as to be placed below the joints C105. The joints C105 are lifted by the joint fork B301, and are connected to the needles B122, thereby establishing ink supply paths between the ink pack C103 of the media pack C100 and the ink supply portions of the subtank of the carriage B104. A supply joint B302 is also formed in the body of the printer unit B100 so as to be placed below the air supply port B123 (see FIG. 8) of the carriage B104 which has moved to the home position. The supply joint B302 is connected to a pump cylinder B304 of a pump serving as a negative pressure generating source with a supply tube B303 therebetween. The supply joint B302 is lifted by a joint lifter B305, and is connected to the air supply port B123 of the carriage B104, thereby establishing negative pressure introducing paths between the negative pressure inlets of the subtank of the carriage B104, and the pump cylinder B304. The joint lifter B305 vertically moves the joint fork B301 together with the supply joint B302 by the driving force of a joint motor M003.

A gas-liquid separating member (not shown) is provided in the negative pressure inlet of the subtank so as to allow air to pass therethrough and not allow ink to pass therethrough. The gas-liquid separating member allows air in the subtank, which is sucked through the negative pressure inlet, to be passed therethrough, thereby supplying ink from the media pack C100 into the subtank. When a sufficient amount of ink is supplied until the ink in the subtank reaches the gas-liquid separating member, the gas-liquid separating member prevents the ink from being passed therethrough, and the supply of the ink is automatically stopped. The gas-liquid separating member is disposed in the ink supply portion of the ink containing portion for each color ink in the subtank, and automatically stops the supply of the ink into the ink containing portion.

A suction cap B310 is disposed in the main body of the printer unit B100 so as to cap the recording head B120 (see FIG. 8) of the carriage B104 placed in the home position. Negative pressure is applied from the pump cylinder B304 into the suction cap B310 through a suction tube B311, and ink is thereby discharged by suction from the ink discharging outlets B121 of the recording head B120 (suction recovery). The recording head B120 discharges ink, which is not used for image recording, into the suction cap B310, as necessary (preliminary discharging). The ink in the suction cap B310 is discharged from the pump cylinder B304 into the ink absorber C107 in the media pack C110 through an ink discharge tube B312 and an ink discharge joint B313.

The pump cylinder B304 constitutes a pump unit B315 with a pump motor M004 for reciprocally moving the pump cylinder B304, and the like. The pump motor M004 also functions as a driving source for vertically moving a wiper lifter B316 (see FIG. 10). The wiper lifter B316 lifts the wiper C106 of the media pack C100, which is loaded in the printer unit B100, to a position where the wiper C106 can wipe the recording head B120.

In FIGS. 10 and 11, a pump HP sensor B321 detects whether the pump constituted by the pump cylinder B304 is placed in the home position. A joint HP sensor B322 detects whether the ink supply paths and the negative pressure introducing paths described above have been formed. A chassis B323 constitutes the main body of the printer unit B100.

D. Signal Processing System

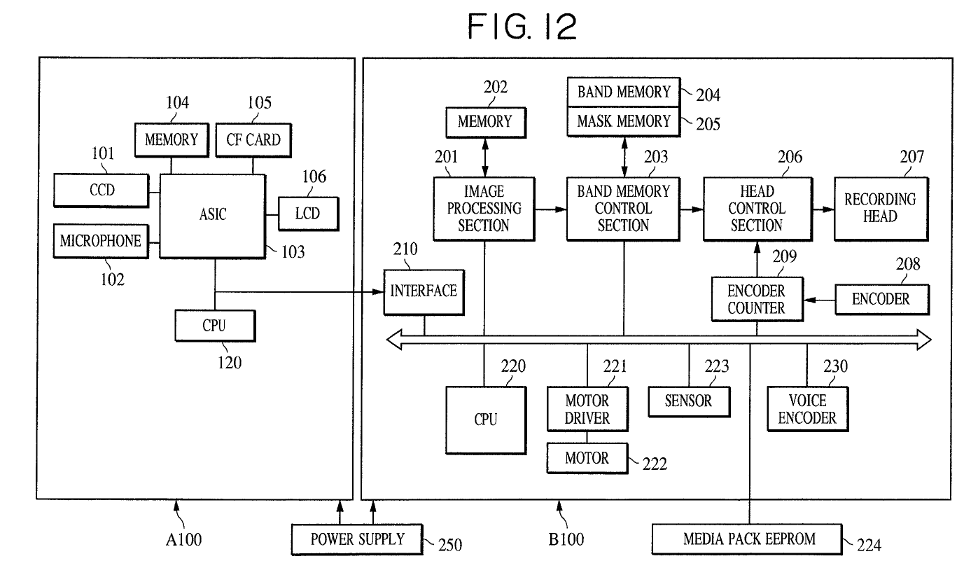

FIG. 12 is a general block diagram of the camera unit A100 and the printer unit B100.

The camera unit A100 comprises a CCD 101 serving as an image pickup device, a microphone 102 for voice input, an ASIC 103 for executing hardware processing, a first memory 104 for temporarily storing image data and the like, a CF card 105 (corresponding to the CF card A107) for storing a captured image, an LCD 106 (corresponding to the liquid crystal display A105) for displaying a captured image or a reproduced image, and a first CPU 120 for controlling the camera unit A100.

The printer unit B100 comprises an interface 210 between the camera unit A100 and the printer unit B100, an image processing section 201 (including a binarizing section for binarizing an image), a second memory 202 used for image processing, a band memory control section 203, a band memory 204, a mask memory 205, a head control section 206, a recording head 207 (corresponding to the recording head B120), an encoder 208 (corresponding to the encoder sensor B131), an encoder counter 209, a second CPU 220 for controlling the printer unit B100, a motor driver 221, a motor 222 (corresponding to the motors M001, M002, M003, and M004), a sensor 223 (including the HP sensors B134, B321, and B322), an EEPROM 224 incorporated in the media pack C100, a voice encoder 230, and a power supply 250 (corresponding to the battery A108) for supplying power to the entire apparatus.

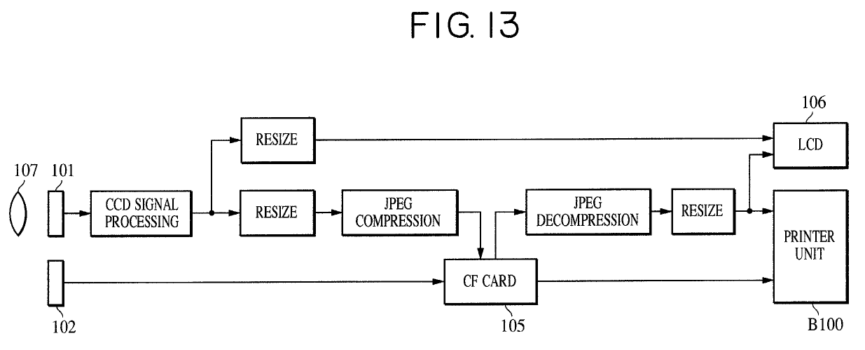

FIG. 13 is an explanatory view of signal processing in the camera unit A100. During an image-capturing mode, an image captured by the CCD 101 through a lens 107 is subjected to signal processing (CCD signal processing) by the ASIC 103, and is converted into YUV luminance and chrominance signals. The signals are further resized to a predetermined resolution, are subjected to JPEG compression, and are recorded in the CF card 105. Sound is input from the microphone 102, and is stored in the CF card 105 through the ASIC 103. Sound may be stored simultaneously with image capturing, or may be stored after image capturing. During a playback mode, the JPEG image is read from the CF card 105, is subjected to JPEG decompression by the ASIC 103, is resized to a display resolution, and is displayed on LCD 106.

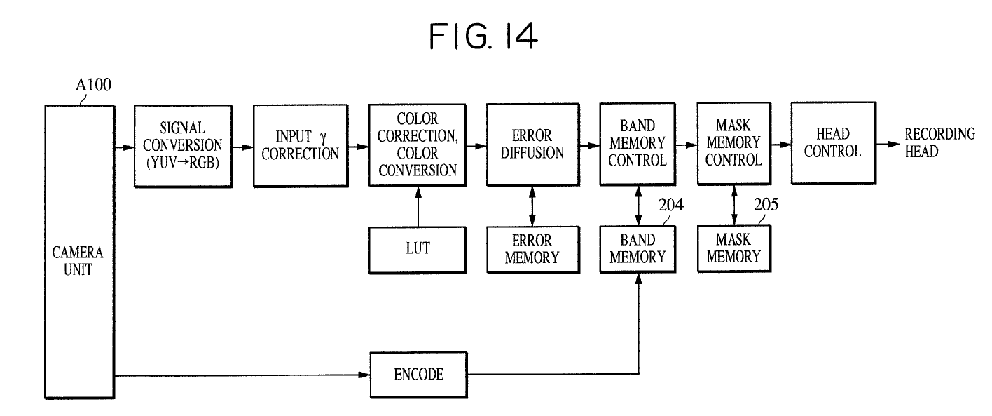

FIG. 14 is an explanatory view of signal processing in the printer unit B100.

An image played back in the camera unit A100, that is, an image read from the CF card 105, is subjected to JPEG compression by the ASIC 103, and is resized to a resolution suitable for printing, as shown in FIG. 13. Then, the resized image data (YUV) is transmitted to the printer unit B100 through the interface 210. In the printer unit B100, as shown in FIG. 14, the image data from the camera unit A100 is transmitted to the image processing section 201 so as to be subjected to conversion into RGB signals, input gamma correction in accordance with the camera characteristics, color correction and color conversion with a lookup table (LUT), and binarization for printing. During a binarization process, the second memory 202 is used as an error memory so as to perform error diffusion (ED). While the binarizing section in the image processing section 201 performs error diffusion in this embodiment, it may perform other processing, such as binarization using a dither pattern. The band memory control section 203 temporarily stores binarized print data in the band memory 204. Every time the carriage B104 with the recording head 207 and the encoder 208 moves by a predetermined amount, an encoder pulse is input from the encoder 208 to the encoder counter 209 of the printer unit B100. Print data is read from the band memory 204 and the mask memory 205 in synchronization with the encoder pulses, and the head control section 206 controls the recording head 207 based on the print data so as to perform recording.

Band memory control in FIG. 14 will now be described below.

A plurality of nozzles in the recording head 207 are arrayed so as to achieve a density of, for example, 1200 dpi. In order to perform one scanning operation of the carriage to record an image with such a recording head 207, it is necessary to previously create recording data (recording data for one scan) corresponding to the number of nozzles in the sub-scanning direction (hereinafter also referred to as “longitudinal direction” or “Y-direction”) and corresponding to a recording region in the main scanning direction (hereinafter also referred to as “transverse direction” or “X-direction”). Recording data created by the image processing section 201 is temporarily stored in the band memory 204 by the band memory control section 203. After recording data for one scan is stored in the band memory 204, the carriage is moved in the main scanning direction. At this time, encoder pulses input from the encoder 208 are counted by the encoder counter 209, recording data is read from the band memory 204 in response to the encoder pulses, and ink droplets are discharged from the recording head 209 on the basis of the recording data. In a case of a bidirectional printing method in which images are printed during forward and backward motion of the recording head 207 (forward printing and backward printing), image data is read from the band memory according to the scanning direction of the recording head 207. For example, the address of image data read from the band memory 204 is sequentially incremented in forward printing, and the address of image data read from the band memory 204 is sequentially decremented in backward printing.

In reality, image data (C, M, Y) created by the image processing section 201 are written in the band memory 204 and image data for one band are prepared, and the recording head 207 is ready for scanning. Subsequently, the recording head 207 is moved for scanning, image data is read from the band memory 204, and the recording head 207 records images based on the image data. During an image recording operation, image data to be recorded in the next operation are created by the image processing section 201. The image data are written in a region of the band memory 204 corresponding to the recording position.

In this way, the band memory control is executed while switching the operation of writing recording data (C, M, Y), created by the image processing section 201, into the band memory 204, and the operation of reading out the recording data (C, M, Y) to be transmitted to the head control section 206.

Mask memory control in FIG. 14 will be described below.

The mask memory control is necessary for multipass printing. In multipass printing, a recording image for one line, which has a width corresponding to the length of the array of nozzles of the recording head 207, is recorded in a plurality of scanning operations of the recording head 207. That is, the amount of feeding of a printing medium, which is intermittently fed in the sub-scanning direction, is set to be 1/N of the length of the nozzle array. For example, when N equals two, a recording image for one line is recorded in two scanning operations (two-pass printing), and when N equals four, a recording image for one line is recorded in four scanning operations (four-pass printing). Similarly, when N equals eight, eight-pass printing is performed, and when N equals sixteen, sixteen-pass printing is performed. Therefore, a recording image for one line is completed by a plurality of scanning operations of the recording head 207.

In reality, the mask memory 205 stores mask data for assigning image data to a plurality of scanning operations of the recording head 207, and the recording head 207 discharges ink and records an image based on the AND of the mask data and the image data.

In FIG. 14, voice data stored in the CF card 105 is transmitted to the printer unit B100 via the interface 210 by the ASIC 102 in a manner similar to that of image data. The voice data transmitted to the printer unit B100 is encoded by the voice encoder 230, and is recorded as code data in a print image. When it is unnecessary to incorporate voice data in the print image, or when an image having no voice data is printed, of course, the encoded voice data is not printed, but only the image is printed.

While the printer-containing camera formed of a combination of the camera unit A100 and the printer unit B100 has been described in this embodiment, similar functions can be obtained even when the camera unit A100 and the printer unit B100 are separately formed and are connected by the interface 210.

An example of a characteristic structure of the present invention will be described below.

E. Example

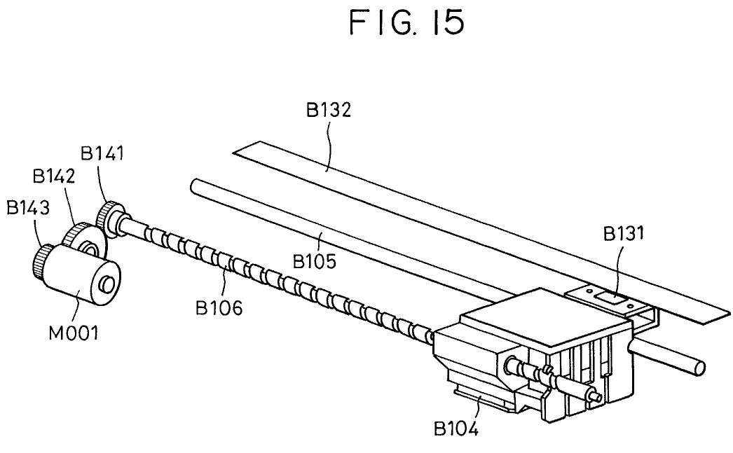

FIG. 15 is a perspective view showing a carriage and its surroundings in an ink-jet recording apparatus according to the present invention. The general structure thereof has been described in Section C-1 “Printing Section” in the basic configuration. In FIG. 15, reference numerals B104, B105, and B106 respectively denote a carriage, a guide shaft, and a lead screw also serving as a guide shaft which forms a pair with the guide shaft B105. Bearings are disposed at both ends of the carriage B104 so as to pass the guide shaft B105 and the lead screw B106 therethrough.

The guide shaft B105 is supported by a concave bearing B107 formed at one end of the carriage B104, and the lead screw B106 is passed through a bearing B108 formed at the other end of the carriage B104 (see FIG. 8). Therefore, the carriage B104 moves along the guide shaft B105 and the lead screw B106 extending in parallel with each other. The support of the guide shaft B105 by the guide bearing B107 serves to inhibit the carriage B104 from being rotated by the rotational force of the lead screw B106.

A screw pin B109 is formed inside the lead screw bearing B108 so as to be fitted in a spiral groove of the lead screw B106. The screw pin B109 may be urged against the spiral groove via a spring B110. By this structure, the rotation of the lead screw B106 is converted into the reciprocal motion of the carriage B104 (see FIG. 7).

A lead screw gear B141 is formed at an end of the lead screw B106, and the carriage DC motor M001 functions as a driving source for moving the carriage B104. A motor gear B143 is mounted on a motor shaft of the DC motor M001. An idler gear B142 transmits the driving force (rotation) of the DC motor M001 to the lead screw B106 via the lead screw gear B141.

As is evident from the above description, the lead screw B106 is rotated by the rotation of the DC motor M001, and the carriage B104 is moved for scanning in a predetermined direction by the rotation. The scanning direction is in parallel with the guide shaft B105 and the lead screw B106. The moving direction of the carriage B104 is varied according to the rotating direction of the lead screw B106.

The position of the carriage B104 is precisely detected by reading the encoder scale B132 by the encoder sensor B131.

While the carriage B104 is moved for scanning by the rotational force of the lead screw B106 in FIG. 15, the present invention is also applicable to a method in which two fixed guide shafts are placed at both ends of the carriage B104, and the carriage B104 is moved by the driving force of a carriage belt.

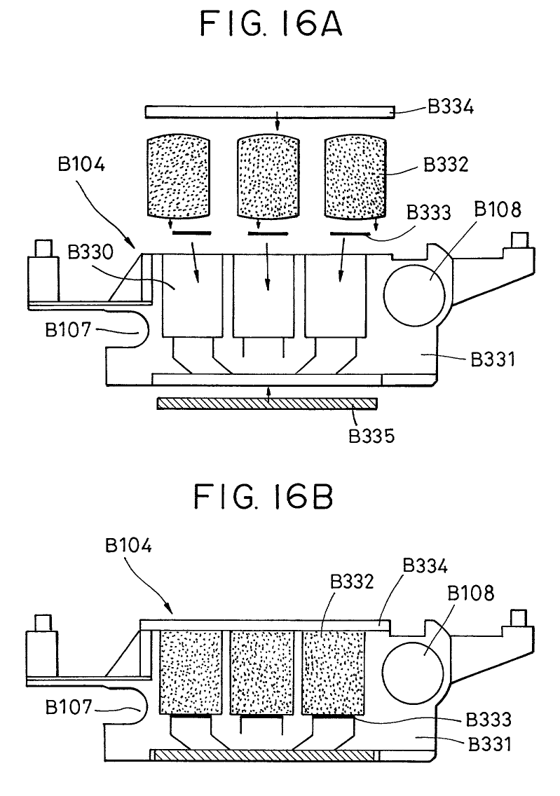

FIGS. 16A and 16B are sectional views of the carriage of the ink-jet recording apparatus of the present invention, respectively showing a state before the carriage is assembled, and a state after the carriage is assembled. That is, the present invention is characterized in that the recording mechanism is formed by incorporating the recording head and the ink tanks in the carriage in order to substantially reduce the size of the apparatus.

In FIGS. 16A and 16B, the concave bearing B107 for the guide shaft B105 and the bearing B108 for the lead screw B106 are molded integrally with the left and right ends of a frame B331 which constitutes the carriage B104. A required number of ink chambers B330 are integrally molded in the frame B331 in a manner similar to that of the bearings B107 and B108. It is preferable that the frame B331 be molded from a synthetic resin.

Ink absorbers B332 having the function of holding ink are formed by, for example, stiffening polypropylene fiber layers, and are contained in a compressed manner in the ink chambers B330. While three ink absorbers are prepared for three colors, yellow, magenta, and cyan, in FIG. 16A, the colors of inks are not limited thereto. If necessary, for example, inks of four colors including black may be used.

Filters B333 serve to remove solids in the ink, and to prevent orifices, which form ink discharging nozzles for discharging ink, that is, the ink discharging outlets B121 (see FIG. 8), from being clogged with dust. The filters B333 are made of a laminated member formed of SUS wires. Reference numeral B334 denotes a cover.

The orifices forming the ink discharging nozzles are formed on the surface (lower surface in the figure) of a heater board B335 serving as a recording head, and a plurality of heaters for discharging ink are incorporated therein. The heaters are electrothermal conversion members serving as energy generating elements for discharging ink so as to generate heat energy for causing film boiling in the ink.

The carriage is formed by mounting the above members, such as the ink absorbers B322, the filters B333, the cover B334, and the heater board B335, in the frame B331. More specifically, after the filters B333 are fixed to the frame B331 by ultrasonic welding or by other means, the ink absorbers B332 are press-fitted in the ink chambers B330 formed in the frame B331, and the cover B334 is fixed to the frame B331 by ultrasonic welding or by other means, thereby forming ink chambers of three colors, yellow, magenta, and cyan. Then, the heater board B335 is bonded to the frame B331 with an epoxy adhesive or the like. The carriage B104 is produced in the above procedure.

A fixed amount of ink, or an amount of ink in accordance with the amount of use is supplied from the main tank (corresponding to the ink packs C103 of the media pack C100 shown in FIG. 4) into each ink chamber B330 of the carriage B104, for example, by a method in which, when the carriage is placed at a predetermined position, the ink chamber and the main tank are connected via the joint to supply ink (sometimes referred to as “pit-in ink supply”).

In the present invention, by supporting both ends of the carriage by the guides, the carriage is allowed to stably move at high speed, and is restrained from shaking. By integrally forming the carriage, the ink tanks, the recording head, and the like, the number of components is reduced, the structure is simplified, and the cost and size are reduced. Therefore, the ink-jet recording apparatus of the present invention is suitable for use in a small printer which is used in a printer-containing camera.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A recording mechanism of an ink-jet recording apparatus for forming an image by discharging ink from at least one ink discharging nozzle onto a recording medium, comprising:
a carriage which is moved for scanning along a guide shaft;
an ink chamber integrally formed in said carriage; and
a recording head comprising the at least one ink discharging nozzle and being integrally mounted on said carriage.

2. A recording mechanism according to claim 1, further comprising an ink tank containing ink to be supplied to said ink chamber, said ink tank being connected to said ink chamber.

3. A recording mechanism according to claim 1, wherein said recording head comprises, as an energy generating element for discharging the ink, an electrothermal conversion member which generates heat energy so as to cause film boiling in the ink.

4. A recording mechanism according to claim 1, wherein said recording head comprises a heater board including an orifice for forming the at least one ink discharging nozzle, and at least one heater for generating heat energy for discharging the ink.

5. A recording mechanism according to claim 1, wherein a plurality of said ink chambers are formed in said carriage.

6. A recording mechanism according to claim 5, wherein said ink chambers contain inks of yellow, cyan, and magenta, respectively.

7. A recording mechanism according to claim 1, wherein said ink chamber comprises a filter and an ink absorber.

8. An ink-jet recording apparatus for forming an image by discharging ink from at least one ink discharging nozzle onto a recording medium, said ink-jet recording apparatus comprising:
a carriage which is moved for scanning along a guide shaft;
a recording head comprising the at least one ink discharging nozzle; and
an ink chamber containing ink to be supplied to said recording head,
wherein said ink chamber is integrally formed in said carriage, and said recording head is integrally mounted on said carriage so that said ink chamber communicates with the at least one ink discharging nozzle.

9. An ink-jet recording apparatus according to claim 8, further comprising an ink tank containing ink to be supplied to said ink chamber, said ink tank being connected to said ink chamber.

10. An ink-jet recording apparatus according to claim 8, wherein a pair of said guide shafts are formed with a row of ink discharging nozzles therebetween, said pair of guide shafts passing through opposite end portions of said carriage so as to be orthogonal to the row of ink discharging nozzles.

11. An ink-jet recording apparatus according to claim 10, wherein one of said guide shafts is a lead screw for driving said carriage.

12. An ink-jet recording apparatus according to claim 8, wherein said recording head comprises, as an energy generating element for discharging the ink, an electrothermal conversion member which generates heat energy so as to cause film boiling in the ink.

13. An ink-jet recording apparatus according to claim 8, wherein said recording head comprises a heater board including at least one orifice for forming the at least one ink discharging nozzle formed on the surface thereof, and at least one heater for generating heat energy for discharging the ink.

14. An ink-jet recording apparatus according to claim 8, wherein a plurality of said ink chambers are formed in said carriage.

15. A recording mechanism according to claim 8, wherein said ink chamber comprises a filter and an ink absorber.

16. An image-capturing apparatus including an ink-jet recording apparatus for forming an image by discharging ink from at least one ink discharging nozzle onto a recording medium, said image-capturing apparatus comprising:
a carriage which is moved for scanning along a guide shaft;
a recording head comprising the at least one ink discharging nozzle; and
an ink chamber containing ink to be supplied to said recording head,
wherein said ink chamber is integrally formed in said carriage, and said recording head is integrally mounted on said carriage so that said ink chamber communicates with the at least one ink discharging nozzle.

17. An image-capturing apparatus according to claim 16, further comprising an ink tank containing ink to be supplied to said ink chamber, said ink tank being connected to said ink chamber.

18. An image-capturing apparatus according to claim 16, wherein a pair of said guide shafts are formed with a row of ink discharging nozzles therebetween, said pair of guide shafts passing through opposite end portions of said carriage so as to be orthogonal to the row of ink discharging nozzles.

19. An image-capturing apparatus according to claim 18, wherein one of said guide shafts is a lead screw for driving said carriage.

20. An image-capturing apparatus according to claim 16, wherein said recording head comprises, as an energy generating element for discharging the ink, an electrothermal conversion member which generates heat energy so as to cause film boiling in the ink.

21. An image-capturing apparatus according to claim 16, wherein said recording head comprises a heater board including at least one orifice for forming the at least one ink discharging nozzle formed on the surface thereof, and at least one heater for generating heat energy for discharging the ink.

22. An image-capturing apparatus according to claim 16, wherein a plurality of said ink chambers are formed in said carriage.

23. An image-capturing apparatus according to claim 16, wherein said ink chamber comprises a filter and an ink absorber.

24. An image-capturing apparatus according to claim 16, further comprising a main body and a camera unit including a lens.

25. An image-capturing apparatus according to claim 24, wherein said ink-jet recording apparatus is provided on said main body.

26. An image-capturing apparatus according to claim 24, further comprising a media pack mountable in said main body, said media pack storing at least one of ink and recording media.

27. An image-capturing apparatus according to claim 26, wherein said media pack stores one of various combinations of ink and recording media.

28. A recording mechanism of an ink-jet recording apparatus for forming an image by discharging ink from an ink discharging nozzle onto a recording medium, comprising:
a carriage comprising an ink chamber containing ink to be supplied to said ink discharging nozzle;
a bearing formed in said ink chamber so as to allow said carriage to be moved for scanning along a guide shaft; and
a recording head comprising the ink discharging nozzle, said recording head being integrally mounted on said ink chamber.

29. A recording mechanism according to claim 28, further comprising an ink tank containing ink to be supplied to said ink chamber, said ink tank being connected to said ink chamber.

30. An ink-jet recording apparatus for forming an image by discharging ink from an ink discharging nozzle onto a recording medium, said ink-jet recording apparatus comprising:
a recording head comprising the ink discharging nozzle; and
an ink chamber containing ink to be supplied to said recording head,
wherein said recording head is integrally mounted on said ink chamber, and said ink chamber comprises a bearing for receiving a guide shaft along which said recording head is moved for scanning.

31. A recording mechanism according to claim 30, further comprising an ink tank containing ink to be supplied to said ink chamber, said ink tank being connected to said ink chamber.
